(19) United States
(12) Patent Application Publication
(10) Pub. No.: US 2011/0184804 A1
(43) Pub. Date: Jul. 28, 2011

(54) METHOD AND APPARATUS FOR QUEUING USER ACTION PRIOR TO AUTHENTICATION

(75) Inventors: James L. Sontag, Portland, OR (US); Scott A. Blomquist, Portland, OR (US)

(73) Assignee: Vidoop, LLC, Portland, OR (US)

(21) Appl. No.: 12/598,714

(22) PCT Filed: May 2, 2008
(86) PCT No.: PCT/US08/62435

§ 371 Date: Oct. 11, 2010

Related U.S. Application Data
(60) Provisional application No. 60/915,841, filed on May 3, 2007.

(51) Int. Cl. G06Q 30/00; G06F 15/16; H04L 9/32

(52) U.S. Cl. 705/14.49; 705/14.73; 705/26.1; 705/27.1; 705/14.4; 726/3; 726/7

(57) ABSTRACT

A system and method for queuing a user's selection of a good or service. In a preferred embodiment a user is presented with a dynamic matrix of images during a user identity authentication session. At least one image advertising the good or service is presented within the matrix. The user's performs an action to select the good or service and generates a request to select the good or service. The request to select the good or service is queued at either the user's computer or by an authentication server. Upon authentication of the user's identity, the user's request and identity credential are transmitted to the merchant from the authenticating identity provider and the purchase or rental transaction is completed without requiring the user to authenticate to or directly access the merchant server system.

### CROSS-REFERENCE TO RELATED APPLICATIONS

The present application claims the benefit of U.S. Provisional Application No. 60/915,841 filed on May 3, 2007, the contents of which are incorporated herein fully by reference.

### FIELD OF THE INVENTION

The present invention relates to the field of user authentication and the exchange of information between a computer and a user. More particularly, the invention relates to the queuing of a user request to select an item prior to authentication of a user to a server system.

### SUMMARY OF THE INVENTION

The present invention is directed to a method for selecting an item. The method comprises displaying information to a user. The information identifies the item. In response to the performance of a user action a request to select the item is queued. The user is then authenticated to a server system and upon authentication the request to select the item is transmitted to the server system to update a user profile stored thereon.

The present invention is further directed to a method for selecting an item. The method comprises displaying information identifying the item to a use at a client system and in response to a user action queuing a request to select the item. The identity of the user is then authenticated and the identity of the user and the request to select the item are transmitted to a server system. The user's profile, stored at the server system, is updated using the identity of the user and the request to select the item. The user profile is updated without the user directly providing a username and password to the server system after the user action.

Further still, the present invention is directed to a method for authenticating an identity to a computer system. The method comprises receiving an account identifier and displaying a plurality of images in response to receipt of the account identifier. Each image has a unique image identifier associated therewith. At least one of the images is from a pre-selected category corresponding of the account identifier and at least one of the images comprises an advertisement linked to a server system providing an offering of goods or services. In response to the user action a request to select the offering of goods or services is queued. At least one image identifier associated with the image from the pre-selected category is received and the identity is authenticated based upon the received unique image identifier associated with the image from the preselected category. The request to select the offer of goods or services and the identity are transmitted to the server system upon authentication of the identity.

The present invention also includes an electronic commerce system to complete a network-based transaction. The system comprises a network, a least one user computer, at least one merchant computer, and an authentication server. The user computer, merchant computer and authentication server are networked for communication. The user computer is programmed to generate a queued request to accept a merchant offer of a good or service. The authentication server is programmed to authenticate an identity of the user and to transmit the queued request and the identity of the user to the merchant computer. The merchant computer is programmed to receive the queued request to accept the merchant offer of a good or service and to receive the identity of the user from the authentication server. The merchant computer is further programmed to process the queued request and the identity of the user to complete the transaction.

### DESCRIPTION OF THE FIGURES

FIG. 1 is a diagrammatic representation of a display device for rendering a plurality of images useful in the method of the present invention.

FIG. 2 is a flow chart showing the queuing of user information prior to authentication of the user to a service provider's website.

FIG. 3 is an illustration of a system for queuing user information and authenticating a user to a merchant server system over the Internet.

### DESCRIPTION OF THE INVENTION

Purchasing products and services online has become an increasingly popular with consumers. Typically, the consumer will visit a website of interest and is required to create a user account before being permitted to purchase products from the merchant's website. The user account is generally created to provide the merchant with the user's shipping address, contact information and payment method. Additionally, the user account may be used to track the user's interests by tracking the items viewed and/or purchased from the merchant. Using this information, the merchant may then suggest items the user may wish to review or purchase.

The selection of various items from the merchant's website is generally based on the “shopping cart” model. A purchaser authenticates itself to the merchant's website and is able to select items from the merchant's electronic catalog; the server computer system metaphorically adds that item to a virtual shopping cart. When the purchaser has finished selecting items, the user proceeds to a check out process and provides the merchant with shipping and payment information. In an alternative method the user may purchase items in a “one-click” process. This method also requires the user be logged into the merchant's server before allowing the transaction to complete. Accordingly, current systems and methods allow users to queue items for review or purchase at a later time. However, these systems and methods do not allow an anonymous or a quasi-anonymous user to a website to queue items or changes to its account before being authenticated to the merchant's website.

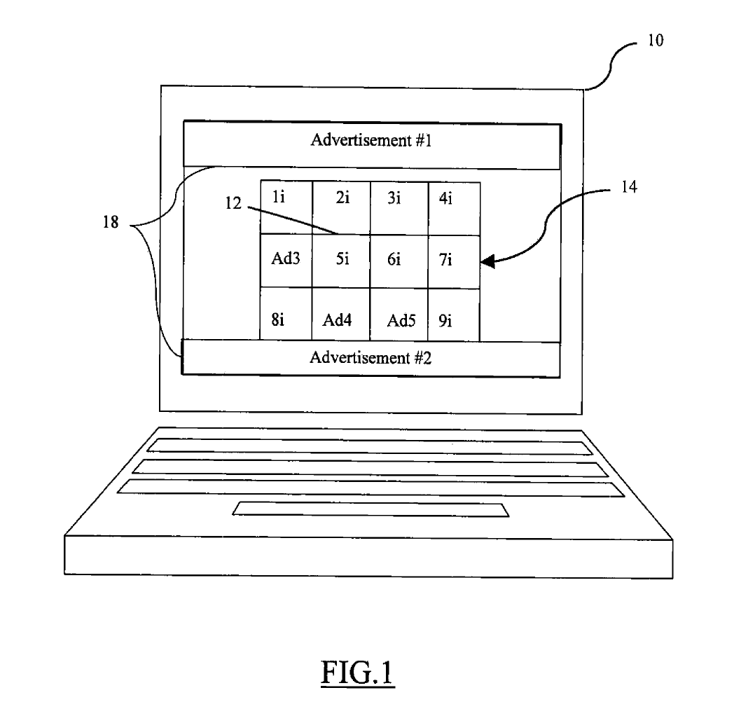

Turning now to the Figures and in particular to FIG. 1, there is shown therein a device 10 comprising a user computer for displaying one or more graphical images such as icons 1i-9i and advertisements Ad3-Ad5 according to a randomly generated arrangement or pattern. The user computer may comprise any user workstation commonly operated by a user to access a computer network and for the purchase of a good or service via the Internet. As used herein the term “advertisement” may be used to describe the presentation of an offering of a good or service to a user. Advertisements (Ad1-Ad5) may be presented to the user in a matrix 14 or in a banner 18 or otherwise presented on a webpage as shown in FIG. 1. An image identifier comprising an alphanumeric character (not shown) may also be randomly generated, associated with each image, and displayed on the display device 10 with the specific image assigned to the image identifier. Use of an image shield and image identifiers as shown in FIG. 1 is more fully disclosed in co-pending and commonly assigned U.S. patent application Ser. Nos. 11/420,061, 11/677,562, 60/888,312, and 29/276,601 (hereinafter “the Authentication Patents”), the contents of which are all incorporated herein by reference.

In accordance with the teachings of the Authentication Patents, a series of randomly selected graphical images and randomly selected corresponding image identifiers are presented to the user at each new authentication session. These images and image identifiers are preferably changed between each authentication session. However, the pre-selected image category or categories selected by the user during an enrollment process remain unchanged for the user until an authorized change is made. Accordingly, the display device 10 may show images selected from both a preselected authenticating category and a non-authenticating category selected by the server running the authentication routine. The image categories are not limited to specific objects but may include broad themes and topics of interest to the user. The graphical images or icons may serve indirectly as constantly-changing yet identifiable reference points for the password elements comprising the unique and randomly assigned image identifiers. It will be appreciated that the graphical images 12 may be arranged in a matrix 14 as disclosed in the Authentication Patents, arrays or any other pattern within the display of a user computer.

In a preferred embodiment of the present invention a different set of images 12 selected from both a pre-selected authenticating category and non-authenticating category and image identifiers associated therewith may be displayed each time the user authenticates to a merchant server, authentication server, or other service provider's server. As discussed above, the graphical images 12 may include images selected for marketing or advertising purposes. For example, a matrix 14 can be displayed having a plurality of advertisements Ad3-Ad5 or messages paid by sponsors or advertisers. The images displayed in the matrix 14 may comprise any one of an infinite number of products or services. By way of example, the matrix 14 may comprise a 3×4 grid comprised of twelve (12) images. In a preferred embodiment at least three of the selected images are selected from an authenticating category while the remaining nine (9) images are selected from non-authenticating categories. For example, one of the images may comprise an advertisement for a website, product or a pending online auction. The image may further include a “link” to the advertiser's server to allow the user to view additional information about the advertised product or service.

The advertisement presented the user during an authentication session may result from user action during or before the authentication session whereby the user requests to preview products such as movies or music. For example, the user may request to preview music from a particular genre. Upon presentation of the matrix described herein the user will then be presented with an image communicating information about the preview music such as the artist name, song title and purchase price. The user may click the image to hear a one-time preview of the music during the authentication session and subsequent operation. This preview may, of course, run in the background of the user's authentication session and subsequent operations without interfering with the user use of the client computer. The user may purchase the previewed music by clicking the advertisement of the song. Alternatively, the music may be automatically queued to the user's account with the music merchant upon authentication of the user's identity and purchase confirmation may be provided at a later time.

In the event the user selects to preview movie titles during the authentication session, the user may be presented a dynamic image displaying the “movie poster” or the actual movie trailer. The user may pre-select the genre of movies he or she wishes to preview during authentication. The trailer may be displayed in front of the matrix or alternatively in a smaller window during authentication and subsequent operation. The movie may either be purchased or rented by the user by clicking the image associated with the movie. Alternatively, the movie may be automatically queued to the user's account with the rental provider or merchant upon authentication of the user's identity and confirmation may be subsequently provided by the user.

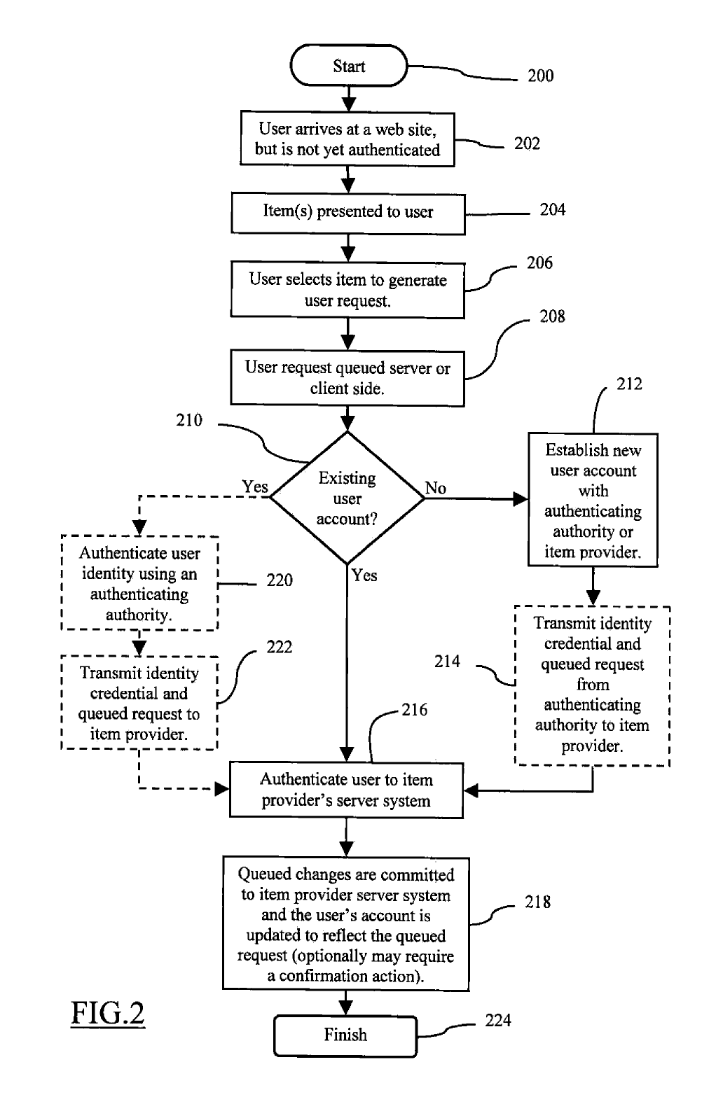

Turning now to FIG. 2 there is shown therein a flow chart illustrating a process for queuing changes to a user's account with a service provider or merchant. The process shown in FIG. 2 allows a merchant or third-party to present an advertisement of an item to a user and accept the user's selection of the item without requiring the user to login directly to the merchant's server or leave the third-party webpage the user is viewing. The user's selection of the item is stored as a queued request until the identity of the user can be authenticated. This request may be stored at the user's computer or by the authentication server. Upon authentication of the user's identity the request and user identity are transmitted to the merchant server and the transaction may be completed. By way of example, during an authentication session using the graphical image authentication shown in FIG. 1, a user may be presented with a plurality of images each having a unique image identifier comprising an alphanumeric character. As discussed above, at least one of the images may comprise an advertisement of an item such as a good or service the user desires to purchase. Alternatively, the image may comprise a product rental suggestion such as a movie by an online movie rental entity. The user may perform an action to select the item. The user action may comprise clicking the image providing the advertisement or mousing over the image to view more details about the merchant's offerings. Performing an action to select the item generates a request to select the item which may be stored at the user's computer, the authentication server or the merchant's server. Once the user's identity is authenticated by the authentication server or the merchant server system the request is applied to the user's account profile and the transaction is completed.

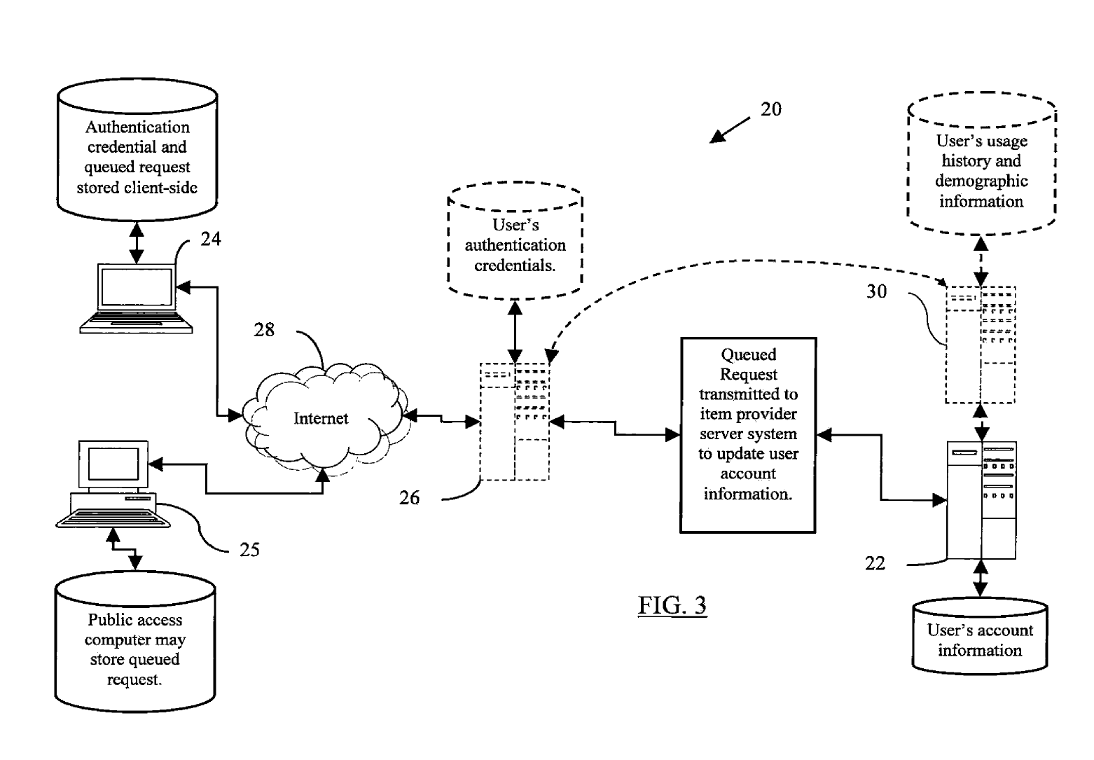

Continuing with reference to FIG. 2, at Step 200 the queuing process begins and the user arrives at a website (Step 202). The website may comprise the website of an authenticating entity or the website of a merchant. One skilled in the art will appreciate that an “authenticating entity” may comprise an Open ID provider acting to verify the identity of the user to the merchant and the merchant to the user. By way of example, upon arrival at an authenticating entities website the user is presented with the dynamic graphical image arrangement (FIG. 1.). As discussed above, the image arrangement may include one or more advertisements for products or services (Step 204). These products and services may be offered either from entities for which the user may, or may not, have already established a user account. The advertisements, as described in U.S. patent application Ser. No. 11/677,562 entitled Methods and Systems for Graphical Image Authentication, may comprise product suggestions based upon the user's purchase history, advertisements for products based upon information from a demographic information server 30 or service providing user demographics to either the merchant server 22 (FIG. 3) or the authentication server 26 (FIG. 3). The demographic information may include the user's purchase history, selected interest, or geographic information.

The user may select the item presented in the matrix or other website by mouse over and click (Step 206). Such action generates a user request that may be stored either client-side or server side (Step 208) until the user's identity is authenticated. It will be appreciated that the user request may be stored server side at either the authentication server 26 (FIG. 3) or at the merchant's server 22 (FIG. 3).

If the user has not been authenticated and is unknown to the website (Step 210) and activity undertaken by the user in advance of authentication is queued anonymously client-side. The user is requested to establish a new user account with an authenticating authority or the item provider (Step 212). After the establishment of a user account, the user's identity credential and queued request is transmitted from the authenticating authority to the merchant or item provider (Step 214). The new user is then authenticated to the item provider's server system (Step 216) and the queued changes are committed and the user's account updated (Step 218).

Alternatively, in the event the authenticating server 26 or merchant server 22 are capable of predicting the user's identity and authenticating the user (Step 216) based upon the device used (personal home computer, work computer, cellular phone or PDA) a preexisting user account, or the presence of a “cookie” or other identifying element present on the user's device, any selections made by the user are queued to the user's account for future commitment to the user's account with the merchant upon authentication (Step 218). In an alternative situation the user may be directed to a third-party authenticating authority (Step 220) for authentication. Upon authentication of the user's identity by the third-party, the user's identity credential and queued request may be transmitted to the item provider from the authenticating authority (Step 222) and the process proceeds to authentication of the user to the item provider or merchant's server system (Step 216) based upon the received identity credential.

Once the user is authenticated to the authenticating authority, any selections made by the user by “clicking” or otherwise selecting an advertisement present on the dynamic graphical image arrangement or on another website are automatically queued to the user's account with the selected merchant. One skilled in the art will appreciate that a confirmation prompt may be presented (not shown) to the user upon successful authentication to confirm any selections. Upon confirmation of the selections the queuing and committing process are completed (Step 224).

Turning now to FIG. 3, there is shown therein, for purposes of illustration, an electronic commerce system 20 adapted to conduct and complete a network-based transaction operable in accordance with the present invention. The system comprises a merchant computer 22, a user computer 24, and an optional authentication server 26 all networked for communication. Optionally, the system may comprise a public access computer 25 such as a device used at an Internet café. The merchant computer 22 may comprise a web server for a financial institution, an online merchant in goods, a brick and mortar merchant or service provider, or a company using the Internet to provide products such as motion pictures or music. One skilled in the art will appreciate that the merchant computer may include any server accessible via the Internet 28 which is adapted to require or include secure user accounts. Such merchant computers 22 may further be adapted to require authentication for the user to access its account. The merchant computer 22 may further be adapted to trust identity credentials provided by the authentication server 26 operated by an identity provider.

The authentication server 26 is programmed to authenticate the identity of the user and to transmit the queued request and the identity of the user to the merchant computer 22. As discussed above, the authentication server 26 may include or be configured to generate an arrangement of pseudo-randomly positioned images or icons each associated with a password element (FIG. 1). The arrangement may include one or more authenticating images, which form at least part of an authenticating sequence. The arrangement generated by the authenticating server may be sent to the user computer 24 via the internet 28 for display on the display device 10 (FIG. 1) of the user computer 24 or public access computer 25. The user may select or input the image identifiers or password element(s) corresponding to the images or icons selected within the arrangement. Alternatively, the user may select any of the images comprising goods or services in which the user is interested in exploring further. For example, the user may be presented with an image from an online movie rental source designed to suggest a movie selection to the user. At this point to user may select the movie by selecting the image. The user's selection is queued to the user's account. Upon successful authentication of the user's identity as described with reference to FIG. 2, the queued request is transmitted to the merchant computer 22 by the authentication server 26. One skilled in the art will appreciate the relationship that may exist between the authentication server 26 and the merchant computer 22 for such queued user account changes to be permanently accepted by the merchant. One such trust relationship may exist under an “Open ID” authentication protocol where the authentication server is trusted by the merchant server to authenticate only users that have established accounts with the merchant.

In an alternative embodiment, the merchant computer 22 may be networked with an optional demographic information server 30 adapted to store user demographic and usage history information. This information may be used by either the authentication server 26 or the merchant server 22 to direct targeted ads at users during an authentication session or while the use is viewing another web page.

In the method of the present invention information in the form of the matrix 14 comprising at least one image comprising an advertisement for a good or service is displayed to the user. In response to the performance of a user action, a request to select the good or service advertised is queued. The request may be queued either at the user's computer 24 or at the authentication server 26. Next, the user may be authenticated to a server system operated by the merchant offering the goods or services advertised. Upon authentication of the user to the merchant's server system 22 or the authentication server 26, the request to select the advertised item is transmitted automatically to the merchant computer server system 22 to update the user's account profile stored thereon. The use of an authentication server 26, as described herein, allows the user to generate an order to purchase the advertised item upon update of the user's account profile and for fulfillment of the user's order to complete the purchase of the item without the user connecting directly to the merchant server system 22 or providing a username and password directly to the merchant server system before or after selecting the good or service.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

What is claimed is:

1. A method for selecting an item, the method comprising:
displaying information to a user, the information identifying the item;
in response to performance of a user action, queuing a request to select the item;
authenticating the user to a server system; and
upon authentication of the user to the server system, automatically transmitting the request to select the item to the server system to update a user profile stored thereon.

2. The method of claim 1 wherein displaying information to a user comprises displaying a plurality of images on a web site page, wherein at least one of the plurality of images comprises an advertisement displaying the item.

3. The method of claim 2 wherein displaying information to a user comprises displaying a plurality of images on a web site page, and wherein at least one of the plurality of images comprises an item selected based upon a user preference.

4. The method of claim 1 wherein authenticating the user to the server system comprises:
displaying a randomly generated grid of randomly selected images, each image having at least one randomly generated unique image identifier associated therewith; wherein at least one of the images is from a pre-selected category corresponding to the user;
receiving at least one randomly generated unique image identifier associated with the image from the pre-selected image category; and
authenticating the user based upon the received unique image identifier associated with the randomly selected image from the pre-selected category.

5. The method of claim 4 wherein at least one of the images comprises the information identifying the item.

6. The method of claim 1 further comprising generating an order to purchase the item upon update of the user profile and fulfilling the generated order to complete purchase of the item, wherein the user profile is updated and the item purchased without the user connecting to the server system.

7. The method of claim 1 wherein the user action comprises a mouse over and click.

8. A method for selecting an item comprising:
displaying information identifying the item to a user at a client system;
in response to a user action, queuing a request to select the item;
storing the request to select the item at the client system;
authenticating an identity of the user;
in response to authentication of the identity of the user, transmitting the identity of the user and the request to select the item to a server system; and
updating a user profile at the server system using the identity of the user and the request to select the item to a server system; whereby the user profile is updated without the user directly providing a username and password to the server system after the user action.

9. The method of claim 8 wherein displaying information identifying the item to a user at a client system comprises displaying a website comprising an advertisement for the item.

10. The method of claim 8 wherein displaying information identifying the item to a user at a client system comprises displaying a grid comprising a plurality of randomly selected images wherein at least one of the plurality of images comprises an advertisement for the item.

11. The method of claim 10 wherein each of the randomly selected images has at least one randomly generated unique image identifier associated therewith; wherein at least one of the images is from a pre-selected category corresponding to the user, wherein authenticating an identity of the user comprises:
receiving at least one randomly generated unique image identifier associated with the image from the pre-selected image category; and
authenticating the user based upon the received unique image identifier associated with the randomly selected image from the pre-selected category.

12. The method of claim 8 further comprising generating an order to purchase the item upon update of the user profile and fulfilling the generated order to complete purchase of the item, wherein the user profile is updated and the item purchased without the user connecting to the server system.

13. The method of claim 8 wherein authenticating the identity of the user comprises the user providing an account identifier and an authentication element to an authentication server and wherein transmitting the identity of the user and the request to select the item to a server system comprises transmitting a confirmation of the identity to the server system from the authentication server and the request to select the item from the client system.

14. A method for authenticating an identity to a computer system, the method comprising:
receiving an account identifier;
displaying a plurality of images, each image having a unique image identifier associated therewith, wherein at least one of the images is from a pre-selected category corresponding to the account identifier and wherein at least one of the images comprises an advertisement linked to a server system providing an offering of goods or services;
in response to a user action, queuing a request to select the offering of goods or services displayed in the advertisement;
receiving at least one image identifier associated with the image from the pre-selected category;
authenticating the identity based upon the received unique image identifier associated with the image from the pre-selected category; and
transmitting the request to select the offer of goods or services displayed in the advertisement and the identity to the server system upon authentication of the identity.

15. The method of claim 14 further comprising generating an order to purchase the goods or services and fulfilling the generated order to complete purchase of the goods or services, wherein purchase of the goods or services is completed without connecting directly to the server system.

16. The method of claim 14 wherein the account identifier is received at an authentication server, wherein the grid of images is generated by the authentication server, and wherein the at least one image identifier associated with the image from the pre-selected category is received at by the authentication server.

17. An electronic commerce system to complete a network-based transaction, the system comprising:
a network;
at least one user computer for operation by a user to purchase a good or service;
at least one merchant computer;
an authentication server;
the at least one user computer, at least one merchant computer and authentication server being interconnected by the network;
the at least one user computer being programmed to generate a queued request to accept a merchant offer of a good or service;
the authentication server being programmed to authenticate an identity of the user and to transmit the queued request and the identity of the user to the merchant computer;
the merchant computer being programmed to receive the queued request to accept the merchant offer of a good or service and to receive the identity of the user from the authentication server; and
the merchant computer being further programmed to process the queued request and the identity of the user to complete the transaction.

18. The system of claim 17 wherein the at least one user computer comprises a display component adapted to display the merchant offer of the good or service to the user.

19. The system of claim 17 wherein the authentication server is independent from the merchant computer.

20. The system of claim 17 wherein the authentication server is adapted to generate an image for display at the at least one user computer, the image comprising an advertisement of the good or service offered by the merchant computer.

21. The system of claim 20 wherein the image further comprises a plurality of randomly selected images, each image comprising a randomly assigned image identifier.
